(19) United States
(12) Patent Application Publication
(10) Pub. No.: US 2025/0363882 A1
(43) Pub. Date: Nov. 27, 2025

(54) SYSTEM, METHOD, AND WEARABLE DEVICE FOR SWIMMER SAFETY

(71) Applicant: Safety Swim LLC, Brooklyn, NY (US)

(72) Inventors: Dorian FERNANDEZ, New York, NY (US); Henry RIPLEY, New York, NY (US); Theodore ULLRICH, New York, NY (US); Julia TIMKO, New York, NY (US); Pepin GELARDI, New York, NY (US)

(21) Appl. No.: 19/216,262

(22) Filed: May 22, 2025

Related U.S. Application Data
(60) Provisional application No. 63/651,322, filed on May 23, 2024.

(51) Int. Cl. G08B 21/08; G01S 11/02; G08B 21/18

(52) U.S. Cl. CPC G08B 21/088; G08B 21/182; G01S 11/02

(57) ABSTRACT

A system and method for swimmer safety that may utilize a wearable device configured to be worn by a swimmer and at least one alert device. The wearable device may include a water contact sensor, an accelerometer, a range detector with Bluetooth Low Energy (BLE) transmitter, a battery, and a real-time state management controller. The water contact sensor may determine when surrounding water exceeds a predetermined water contact threshold. The accelerometer may detect falls. The range detector may determine when the swimmer moves out of range. The controller may receive inputs from these components, manage operational states, and generate real-time state data. The wearable device may transmit alerts upon detecting at least one critical event such as, water contact, a fall, the wearable device being out of range, or low battery.

### PRIORITY

This application claims the benefit of U.S. Provisional Patent Application No. 63/651,322, filed on May 23, 2024, the entire contents of which are hereby incorporated by reference herein.

### FIELD

The field of the present disclosure relates generally to swimmer safety.

### BACKGROUND

Advances in swimmer safety technologies have considerably increased over the years, yet the systems currently available still exhibit significant fragmentation, often focusing only on isolated aspects of swimmer safety without offering a comprehensive solution. This fragmented approach results in substantial limitations, such as the inability of sensors to capture all critical safety metrics effectively or the failure of devices to transmit crucial safety information across practical distances.

A common shortfall among existing devices is their limited capability in comprehensively safeguarding swimmers across all potential scenarios. Many systems are not equipped to dynamically assess and respond to various levels of threats in real-time, leading to delayed or inappropriate responses that fail to mitigate potential dangers efficiently.

Therefore, a substantial gap exists in providing a unified system that not only detects but also prioritizes alerts based on the severity and immediacy of the threat. Current systems do not adequately address the need for prioritized alerting based on real-time risk assessments, often treating all alerts with uniform urgency which can dilute the response effectiveness to truly critical situations, threats and prioritizing alerts based on the severity of danger to the swimmer.

### SUMMARY

The present disclosure introduces a comprehensive system and method that utilizes a wearable device coupled with one or more alert devices.

The wearable device is engineered to be comfortably worn by a swimmer and can be equipped with an array of sensors, including a water contact sensor, an accelerometer, and a range detector. These sensors can be synergistically configured to monitor the swimmer's environmental interactions and movements, enabling the identification and assessment of potentially hazardous situations such as excessive water contact, abrupt falls, or significant deviations from a predefined safety range.

One example of an innovation provided by the present disclosure lies in an advanced alert mechanism, which is capable of differentiating alerts into various levels of urgency. By employing sophisticated algorithms, this system prioritizes alerts, allowing for rapid and appropriate responses tailored to the severity of the detected conditions. This prioritization can serve to ensure that resources are directed to emergent situations, thereby enhancing the efficacy of intervention strategies and significantly improving swimmer safety.

Some embodiments of the present disclosure introduce a system for swimmer safety that may comprise at least one alert device and a wearable device configured to be worn by a swimmer. The wearable device may include a water contact sensor configured to determine when an amount of water surrounding the wearable device exceeds a predetermined water contact threshold. The wearable device may further include an accelerometer configured to detect whether the swimmer has fallen. The wearable device may also include a range detector configured to determine when the swimmer is out of a range of the at least one alert device, where the range detector may comprise a Bluetooth Low Energy (BLE) transmitter. The wearable device may include a battery. The wearable device may also include a real-time state management controller configured to receive inputs from the water contact sensor, the accelerometer, the battery, and the range detector. The real-time state management controller may manage an operational state of the wearable device based on the inputs. The real-time state management controller may also generate real-time state data comprising BLE advertisement data indicating when a water threshold is exceeded, a fall is detected, the wearable device is out of range, a battery level falls below a predetermined voltage, or any combination thereof. The wearable device may be configured to transmit, via the BLE transmitter, at least one alert to the at least one alert device upon at least one critical event chosen from: the amount of water surrounding the wearable device exceeding the predetermined water contact threshold, as determined by the water contact sensor, the swimmer falling, as detected by the accelerometer, the swimmer being out of the range of the at least one alert device for a predetermined amount of time, as determined by the range detector, the battery level falling below a predetermined voltage, or any combination thereof.

In some implementations, a method for swimmer safety may comprise detecting, by a wearable device configured to be worn by a swimmer, at least one critical event comprising an amount of water surrounding the wearable device exceeding a predetermined water contact threshold, as determined by a water contact sensor of the wearable device, the swimmer falling, as detected by an accelerometer of the wearable device, the swimmer being out of range of at least one alert device for a predetermined amount of time, as determined by a range detector of the wearable device, where the range detector may comprise a Bluetooth Low Energy (BLE) transmitter, a battery level falls below a predetermined voltage, or any combination thereof. The method may further comprise generating, by a real-time state management controller of the wearable device, real-time state data comprising BLE advertisement data indicating when a water threshold is exceeded, a fall is detected, the wearable device is out of range, the battery level falls below a predetermined voltage, or any combination thereof. The method may also comprise transmitting, via the BLE transmitter, at least one alert to the at least one alert device upon detection of the at least one critical event.

In some implementations, a device for swimmer safety monitoring may comprise a water contact sensor configured to determine when an amount of water surrounding the device exceeds a predetermined water contact threshold, an accelerometer configured to detect whether a swimmer wearing the device has fallen, a range detector comprising a Bluetooth Low Energy (BLE) transmitter configured to determine when the device is out of range of at least one alert device, a battery, and a real-time state management controller. The real-time state management controller may be configured to receive inputs from the water contact sensor, the accelerometer, and the BLE transmitter, manage an operational state of the device based on the inputs, generate real-time state data comprising BLE advertisement data indicating when a water threshold is exceeded, a fall is detected, or the device is out of range, and transmit, via the BLE transmitter, at least one alert to the at least one alert device upon at least one critical event comprising the amount of water surrounding the device exceeding the predetermined water contact threshold, as determined by the water contact sensor, the swimmer falling, as detected by the accelerometer, the device being out of range of the at least one alert device for a predetermined amount of time, as determined by the BLE transmitter, a battery level falling below a predetermined voltage, or any combination thereof.

The real-time state management controller may update device flags within the at least one alert device based on the real-time state data. The device flags may be incorporated into BLE advertisement data on the at least one alert device. The device flags may comprise at least one of: a device firmware upgrade (DFU) ready flag, an enter sleep mode flag, a water sensor wet flag, a device submerged flag, a low battery flag, and a fall detect flag.

The real-time state management controller may be configured to transmit the BLE advertisement data at a first rate during normal operation, and transmit the BLE advertisement data at a second rate higher than the first rate when the at least one critical event is detected. The first rate may be between 1 Hz and 10 Hz, while the second rate may be between 20 Hz and 100 Hz. The operational state may comprise at least one of: a sleep state, an active state, a critical event triggered state, and a charging state.

In some implementations, the real-time state management controller may transmit at least one alert comprising a moderate level alert, where the moderate level alert may be triggered upon an occurrence of at least one critical event chosen from: the amount of water surrounding the wearable device exceeding the predetermined water contact threshold, as determined by the water contact sensor detecting water for less than a predetermined amount of a water contact time; the swimmer falling, as detected by the accelerometer detecting a fall; the swimmer being out of the range of the at least one alert device for less than a predetermined amount of range time, as determined by the range detector; the battery level falling below a predetermined voltage; or any combination thereof.

In some embodiments, the at least one alert may comprise a high level alert, where the high level alert may be triggered upon the water contact sensor detecting water for greater than or equal to a predetermined amount of a water contact time, indicating that the wearable device has been submerged. The high level alert may also be triggered upon an occurrence of at least two critical events chosen from: the swimmer falling, as detected by the accelerometer; the swimmer being out of the range of the at least one alert device; or the water contact sensor detecting water.

Covered embodiments are defined by the claims, not this summary. This summary is a high-level overview of various aspects and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

### BRIEF DESCRIPTION OF THE DRAWINGS

FIG. 1 depicts a non-limiting example of a system for swimmer safety according to the present disclosure.

FIG. 2 depicts non-limiting examples of alert devices according to the present disclosure.

FIG. 3 depicts a non-limiting example of a wearable device according to the present disclosure, including a non-limiting example of an insertable sensor module.

FIG. 4 depicts a non-limiting example of an alert schema according to some embodiments of the present disclosure.

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

### DETAILED DESCRIPTION

Certain aspects of the present disclosure relate to a system, method, and wearable device designed to enhance the safety of swimmers by addressing various safety concerns through a comprehensive and integrated approach. The present description provides the following detailed examples of the invention, with specific reference to the accompanying drawings.

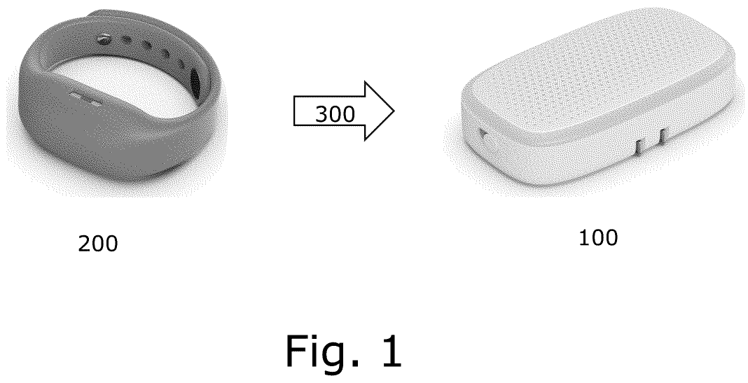

Referring now to FIG. 1, an example system for swimmer safety is depicted, which may include at least one alert device 100 and a wearable device 200 configured to be worn by a swimmer. The wearable device 200 can comprise a water contact sensor, an accelerometer, a range detector, or any combination thereof. These components can function collaboratively to monitor the swimmer's safety and initiate alerts under certain conditions, as further described below. The at least one alert 300 may contain information regarding the nature of at least one critical event, such as whether water surrounding the wearable device has exceeded a predetermined water contact threshold, whether the swimmer has fallen as detected by the accelerometer, whether the swimmer is out of range of the at least one alert device 100, or whether a battery level has fallen below a predetermined voltage.

The wearable device 200 may be designed in various forms such as a wristband, a hip clip, a necklace, an ankle bracelet, a ring, goggles, a swim cap, or any combination thereof. The wearable device 200 may be constructed using at least one waterproof material to ensure functionality in aquatic environments.

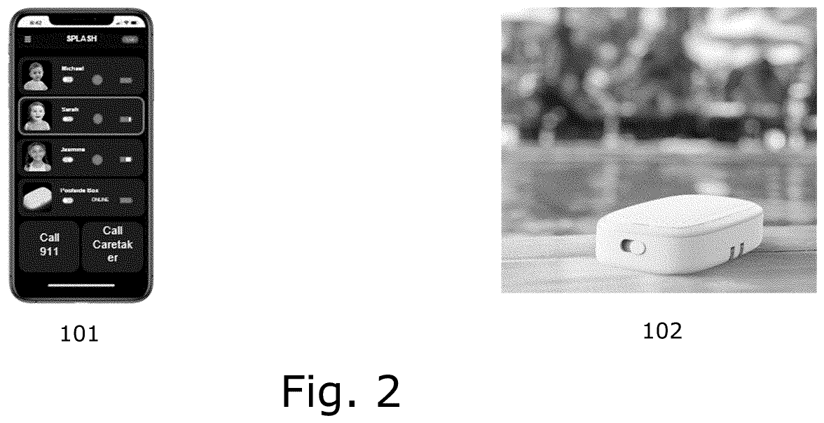

The at least one alert device 100 may include, but is not limited to, a mobile device, such as but not limited to, a smartphone 101 and/or a standalone poolside alert device 102, as shown in FIG. 2. The poolside alert device 102 may receive alerts and notify users of the various alerts generated by the wearable device 200. In some examples, the poolside alert device 102 may work in tandem with the smartphone 101 to extend the range of the poolside alert device or to provide a wireless network connection for the poolside alert device 102.

In some non limiting embodiments, the poolside alert device 102 may feature a compact, ergonomic design. The device may comprise a high-impact, water-resistant polymer composite material with Ultraviolet (UV) protection additives to withstand prolonged exposure to pool chemicals and sunlight. The poolside alert device 102 may also include rounded edges serve both aesthetic and safety purposes by eliminating sharp corners that could cause injury in poolside environments while also enhancing the device's water-shedding capabilities. A button or switch, which may in some embodiments be circular, may be slightly raised from the surface for tactile identification and may incorporate a polymer or silicone membrane to maintain waterproof integrity while providing responsive feedback when pressed or actuated. This poolside alert device 102 may be waterproof with the ability to withstand temporary submersion while maintaining full functionality in humid poolside conditions, with the rounded profile also facilitating easy handling with wet hands.

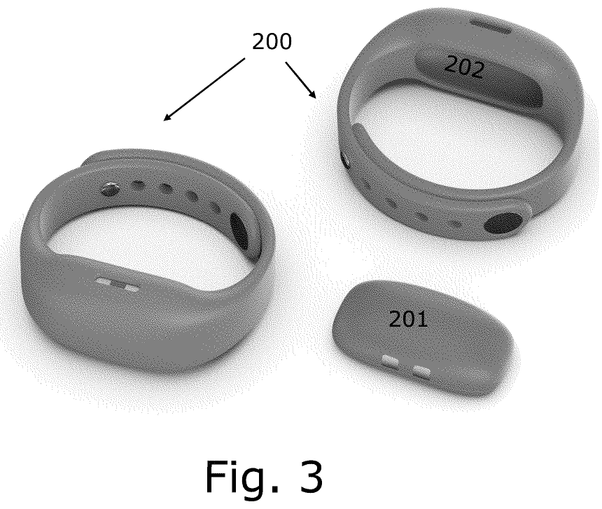

As illustrated in FIG. 3, the wearable device 200 may be designed for comfort and efficiency, available in configurations such as a wristband. However, the wristband shown in FIG. 3 is not limiting and in some embodiments, the wearable device 200 may comprise a necklace, an ankle bracelet, a ring, goggles, a swim cap, or a hip clip (not shown), or any combination thereof. In certain aspects, the wearable device 200 may house a sensor module 201 within compartment 202, which can allow for easy integration or replacement of the sensor module. The sensor module 201 may comprise the water contact sensor, accelerometer, and range detector in certain implementations. While FIG. 3 illustrates the sensor module 201 as being insertable inside the compartment 202, this configuration may not be utilized in all embodiments. The sensor module 201 may alternatively be integral with the wearable device 200. In some implementations, the sensor module 201 may be insertable by a manufacturer but not by the end user. These various configurations may provide flexibility in manufacturing, maintenance, and use of the wearable device 200.

The wearable device 200 and any associated components, can be constructed using waterproof materials to ensure durability and reliability in aquatic environments. In certain instances, the water contact sensor includes pins (not shown) that actuate upon reaching a predetermined water contact threshold, effectively detecting when the swimmer is submerged or in contact with water at levels that may indicate a risk. In certain examples, the entire wearable device 200 is waterproof with the pins preventing entry of water into the compartment 202.

The predetermined water contact threshold may be defined as any quantitative measure that determines when water has entered the device. In one embodiment, the predetermined water contact threshold may include water pressure measurements. In other embodiments discussed below, the predetermined water contact threshold may include water contact time measurements. The water contact sensor may function through various mechanisms to detect when the predetermined water contact threshold has been exceeded. In some embodiments, the water contact sensor may utilize electrical conductivity principles, where the presence of water may complete an electrical circuit between the pins of the sensor. The water contact sensor may be configured to detect not only the presence of water but also the duration of water contact, which may be particularly relevant for distinguishing between splash events and actual submersion events.

In certain examples, the wearable device 200 may include an accelerometer. This accelerometer may also be present within the sensor module 201. The accelerometer may be calibrated to detect when the swimmer has fallen, a crucial safety measure for preventing unnoticed accidents. The range detector may also be present in the sensor module 201. The range detector may be capable of detecting frequencies ranging from 1 GHz to 10 GHz including all nested intermediate ranges. The range detector may also incorporate Wi-Fi and Bluetooth capabilities including Bluetooth Low Energy (BLE), allowing the range detector to determine when the swimmer is out of range of the at least one alert device 100.

In some examples, the range detector may incorporate Wi-Fi capabilities in addition to the Bluetooth Low Energy (BLE) capabilities. These Wi-Fi capabilities may allow for communication between components of the system, extending the functionality of the wearable device 200 beyond the local range limitations of Bluetooth. The Wi-Fi capabilities may enable a user to use the system remotely from anywhere with internet connectivity, further extending the range of the components beyond the physical proximity required by Bluetooth alone. In certain implementations, the wearable device 200 may connect to a local Wi-Fi network directly, or may connect to the internet through the poolside alert device 102 which may serve as a gateway. This extended connectivity may allow the wearable device 200 to transmit alerts and status information to the at least one alert device 100 even when the user is not within Bluetooth range of the wearable device 200. For example, a parent or caregiver may receive alerts on their smartphone 101 regarding the swimmer's safety status while away from home, provided there is internet connectivity at both locations. The Wi-Fi capabilities may also facilitate firmware updates, configuration changes, and data synchronization between the wearable device 200 and cloud-based services that may be accessed by the at least one alert device 100. In some implementations, the poolside alert device 102 may include a Wi-Fi module that creates a bridge between the Bluetooth communications from the wearable device 200 and the wider internet, allowing for seamless integration of local and remote monitoring capabilities. This dual communication approach using both Bluetooth and Wi-Fi may provide redundancy in the communication system, ensuring that alerts reach intended recipients through multiple pathways.

In certain non-limiting aspects, the range detector may incorporate a Bluetooth Low Energy (BLE) transmitter. “Bluetooth Low Energy,” commonly referred to as BLE, is defined as a wireless personal area network technology designed for short-range communication with reduced power consumption while maintaining a similar communication range to classic Bluetooth. BLE may be advantageous in the current implementation due to its low energy requirements, which may extend battery life of the wearable device 200, while still providing reliable communication capabilities for safety monitoring. By utilizing BLE, the wearable device 200 may maintain consistent communication with the alert device 100 while conserving battery power, ensuring that the safety monitoring system remains operational for extended periods without requiring frequent recharging.

The incorporation of BLE in the range detector, combined with a real-time state management controller (described in further detail below) and, in some embodiments, the updating of BLE advertisement data and device flags, may provide an unexpected effect of improved safety through efficient power management and reliable communication protocol. This is unexpected because differences between transfer rates may impact device communication. However, using the real-time state management controller, the lower transfer rate (regular Bluetooth has rate of 2.1 Mbps, while Bluetooth Low Energy has a transfer rate of up to 1 Mbps) unexpectedly improves device communication and battery life while the real-time state management controller allows for safety to be maintained. The real-time state management controller optimizes the communication protocol by intelligently managing when and how data is transmitted, effectively compensating for the lower bandwidth of BLE. By implementing strategic data prioritization and efficient state transitions, the controller ensures that an alert 300 is transmitted without delay while simultaneously reducing power consumption during normal operation. This approach transforms what would typically be considered a technical limitation into an advantage for wearable safety devices, where battery longevity and reliable communication are paramount concerns. The real-time state management controller's ability to dynamically adjust transmission parameters based on detected events further enhances this unexpected benefit, allowing the system to maintain safety standards while operating within the constraints of lower-bandwidth BLE technology.

The BLE transmitter within the range detector may be configured to transmit data packets at predetermined intervals. These data packets may include real-time state data comprising BLE advertisement data that may indicate when a water threshold is exceeded, a fall is detected, or the wearable device 200 is out of range. This advertisement data may be structured to include device flags that may represent various states of the wearable device 200. The “BLE advertisement data” is defined as the information transmitted by a BLE device during its advertising process. This data may be broadcast periodically by the wearable device to announce its presence and communicate safety information to nearby receiving devices. The BLE advertisement data may follow the standard BLE protocol format while containing customized information specific to the swimmer safety system, method and wearable device described herein.

In certain implementations, the BLE transmitter may be configured to operate in different power states based on the operational state of the wearable device 200. For example, the BLE transmitter may operate in a low-power state during normal operation and transition to a high-power state when at least one critical event is detected. This adaptive power management may further enhance battery life while ensuring reliable communication during emergency situations.

The BLE transmitter may include a manufacturer data structure that may contain a device identifier, (e.g., an iOS counter, or an Android counter) for maintaining connections with mobile operating systems (e.g., iOS or Android devices), and device flags. The device flags may include, but are not limited to, a device firmware upgrade (DFU) ready flag, an enter sleep mode flag, a water sensor wet flag, a device submerged flag, a low battery flag, and a fall detect flag. These flags may be updated in real-time by a real-time state management controller based on inputs from the water contact sensor, accelerometer, and range detector.

A real-time state management controller may be configured to manage the operational state of the wearable device 200 based on the inputs from the various sensors. The operational states may include, but are not limited to, a sleep state, an active state, a critical event triggered state, and a charging state. Each state may have different configurations for the BLE transmitter, such as different advertising intervals or transmission power levels. In some non-limiting implementations, the real-time state management controller may be programmed using the Nordic UART Service (NUS) from Nordic Semiconductor.

The operational state of the wearable device may include a sleep state, an active state, a critical event triggered state, and a charging state, each with distinct characteristics and functionalities. The sleep state may be characterized by minimal power consumption with the water contact sensor, accelerometer, and range detector in low-power modes, while maintaining wake-on-motion capability through the accelerometer. During this state, BLE advertising may be disabled to conserve battery power, and the device may only transition to the active state upon motion detection. The active state may feature full sensor monitoring with regular BLE advertising at a first rate (e.g., between 1 Hz and 10 Hz), enabling normal safety monitoring while optimizing power consumption. In this state, the device may continuously monitor for water contact, falls, and range conditions while periodically checking battery voltage.

The critical event triggered state may be entered when at least one critical event is detected, such as water contact exceeding the predetermined threshold, fall detection, the device being out of range, or the battery level falling below a predetermined voltage. In this state, the BLE advertising rate may increase to a second rate (e.g., between 20 Hz and 100 Hz) to ensure timely propagation of an alert 300, and the device may transmit specific device flags within the BLE advertisement data to indicate the nature of the critical events. The charging state may be activated when the device is connected to a power source, potentially triggering device firmware upgrade (DFU) functionality and setting the DFU ready flag in the advertisement data. Transitions between states may occur based on specific conditions: motion detection may trigger transition from sleep to active state; critical event detection may trigger transition from an active to a critical event triggered state; inactivity for a predetermined period may trigger transition from active to sleep state; and connection to or disconnection from a power source may trigger transitions to or from the charging state, respectively.

The real-time state management controller may be configured to operate at different rates depending on the operational state of the wearable device. In the context of the present disclosure, “real time” may refer to the frequency at which the controller processes inputs from sensors, updates device states, and transmits data. The real-time state management controller may operate at a frequency between 1 Hz and 100 Hz, including all nested intermediate ranges. More specifically, during normal operation, the controller may operate at a frequency between 1 Hz and 10 Hz, including all nested intermediate ranges such as 2 Hz to 8 Hz, 3 Hz to 7 Hz, or 4 Hz to 6 Hz. In certain implementations, the normal operation frequency may be approximately 5 Hz, corresponding to processing sensor inputs and updating device states every 200 milliseconds.

When at least one critical event is detected, such as water immersion, a fall, the device being out of range, the battery level falling below a predetermined voltage, or any combination thereof, the real-time state management controller may increase its operating frequency to between 20 Hz and 100 Hz, including all nested intermediate ranges such as 25 Hz to 75 Hz, 30 Hz to 60 Hz, or 40 Hz to 50 Hz. In certain implementations, this increased frequency may be approximately 50 Hz, corresponding to processing sensor inputs and updating device states every 20 milliseconds. This increased frequency may enable more responsive alerting and more accurate monitoring during potentially dangerous situations.

As defined herein, a “critical event” may be any event that triggers an alert 300 that might be indicative of an unsafe situation, with the real time state controller and other components managing and prioritizing the alert 300. The critical event may include, but may not be limited to, the amount of water surrounding the wearable device exceeding the predetermined water contact threshold, the swimmer falling as detected by the accelerometer, the swimmer being out of range of the at least one alert device for a predetermined amount of time, the battery level falling below a predetermined voltage, or any combination thereof. The real time state management controller may process these critical events, determine their severity, and manage the appropriate response, which may include adjusting transmission parameters, updating device flags, and ensuring timely delivery of at least one alert 300 to connected alert devices 100.

The real-time state management controller may be implemented as a state machine with defined states including, but not limited to, a sleep state, an active state, a critical event triggered state, and a charging state. In the sleep state, the controller may disable the Bluetooth Low Energy (BLE) transmitter, configure the accelerometer for wake-up detection, clear all interrupts, and reset all device flags. The controller may then enter a low-power mode until motion is detected.

In the active state, the real-time state management controller may enable the BLE transmitter at a standard power level, configure the water sensor and accelerometer for fall detection, and begin monitoring for at least one critical event. The controller may maintain this state as long as periodic motion is detected, indicating that the wearable device is being used.

When at least one critical event is detected, such as a fall or water immersion, the real-time state management controller may transition to a critical event triggered state. In this state, the controller may increase the BLE transmission frequency from the normal operation rate to the higher rate, enabling more frequent updates to connected alert devices, such as the poolside box 102 or a mobile device 101. The controller may also set appropriate device flags in the BLE advertisement data to indicate the specific critical event that have been detected.

The real-time state management controller may manage transitions between these states based on inputs from the water contact sensor, accelerometer, and range detector. For example, when the accelerometer detects motion after a period of inactivity, the controller may transition from the sleep state to the active state. Similarly, when the water contact sensor detects water immersion, the controller may set appropriate flags and may increase the BLE transmission frequency.

The real-time state management controller may also manage various timers for state transitions and alert conditions. For example, an inactivity timer may be used to transition from the active state to the sleep state after a predetermined period of inactivity, such as, but not limited to, 10 minutes. Similarly, timers may be used to automatically clear alert conditions after predetermined periods, such as, but not limited to, 15 seconds for fall detection or 20 seconds for water detection.

The real-time state management controller may update device flags within the BLE advertisement data based on the inputs from the various sensors. These device flags may include, but are not limited to, a device firmware upgrade (DFU) ready flag, an enter sleep mode flag, a water sensor wet flag, a device submerged flag, a low battery flag, and a fall detect flag. These flags may be incorporated into the BLE advertisement data and transmitted to connected alert devices, allowing for real-time monitoring of the wearable device's status.

The controller may also manage power consumption by adjusting the operational state of various components based on the current state of the wearable device. For example, in the sleep state, the controller may disable the BLE transmitter and configure the accelerometer for low-power wake-up detection. In the active state, the controller may enable the BLE transmitter and configure the sensors for full monitoring capabilities. This adaptive power management may extend battery life while ensuring that critical safety monitoring functions remain operational.

The real-time state management controller may also handle battery monitoring through an analog-to-digital converter (ADC). The controller may periodically sample the battery voltage and compare it against a predetermined threshold. When the battery voltage drops below this threshold, the controller may set a low battery flag in the BLE advertisement data, alerting connected devices to the low battery condition.

The real-time state management controller may also manage a custom BLE service with characteristics for sensor data and device version information. When connected to an alert device 100, such as but not limited to the poolside box 102 or a mobile device 101, the controller may allow notifications for sensor data, allowing for more detailed monitoring of the wearable device's status beyond what is possible through the BLE advertisement data alone.

The wearable device 200 may be designed with user ergonomics in mind, ensuring it remains secure and comfortable during various aquatic activities. It offers a customizable interface on its companion app, which allows users or caregivers to tailor alert thresholds and notification modalities to meet personal safety needs and preferences. This could include choices between auditory and vibratory alerts, customizable alert sounds, and specific configurations for emergency contact protocols, thus providing a personalized and adaptive user experience.

Some embodiments of the disclosure may relate to a method for swimmer safety that involves transmitting at least one alert 300 from the wearable device 200 to the at least one alert device 100 under various conditions or combinations of conditions that suggest the swimmer is at risk. This method can incorporate an innovative alert schema that categorizes alerts 300 into predetermined levels, tailoring response strategies to the severity of detected conditions.

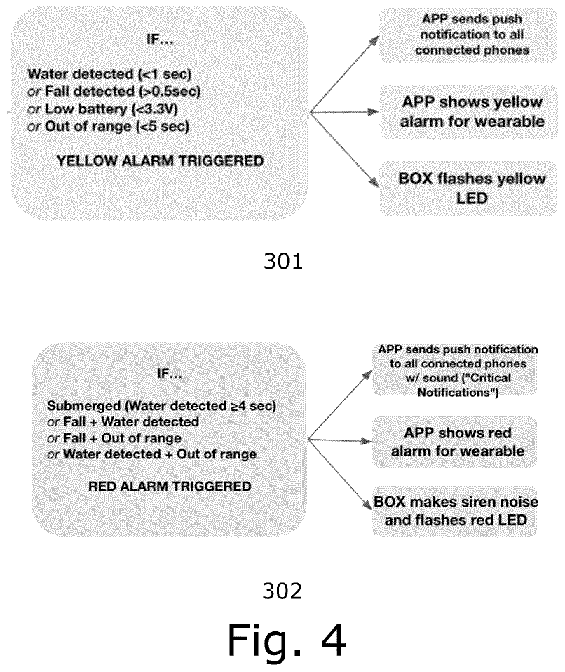

The method, system, and wearable device 200 described herein may employ an alert schema to effectively transmit and prioritize alerts 300, as depicted in FIG. 4. This alert schema may differentiate alerts 300 into moderate alert 301 and high alert 302 based on the severity of the situation. The designations medium and high may serve to indicate the relative severity of alerts 300, with high denoting a more critical condition than medium. “A moderate alert,” as defined herein, indicates that there may be a drowning incident, while a “high alert,” as defined herein may signify that there is a relatively high likelihood of a drowning incident. The moderate alert may serve as an initial warning that requires attention, whereas the high alert may necessitate immediate intervention due to the increased probability of danger to the swimmer.

In certain aspects, a moderate alert 301 may be triggered upon a 50% or lower likelihood of a drowning incident, a 40% or lower likelihood of a drowning incident, a 30% or lower likelihood of a drowning incident, a 20% or lower likelihood of a drowning incident, a 10% or lower likelihood of a drowning incident, or any likelihood within these ranges. The moderate alert 301 may also be triggered upon a likelihood of a drowning incident within ranges of 10-50%, 20-50%, 30-50%, 40-50%, 10-40%, 10-30%, 10-20%, or any combination thereof. These ranges may provide flexibility in configuring the system to balance sensitivity and specificity of alerts 300 based on user preferences and safety requirements.

In some aspects, a high alert 302 may be triggered upon a greater than 50% likelihood of a drowning incident, a greater than 60% likelihood of a drowning incident, a greater than 70% likelihood of a drowning incident, a greater than 80% likelihood of a drowning incident, a greater than 90% likelihood of a drowning incident, or a 100% likelihood of a drowning incident. The high alert 302 may also be triggered upon a likelihood of a drowning event within ranges of 50-100%, 60-100%, 70-100%, 80-100%, 90-100%, 50-90%, 50-80%, 50-70%, or 50-60%. These ranges may allow for customization of an alert threshold based on the specific safety needs of the swimmer and the preferences of the caregiver or monitoring individual.

The moderate alert 301 may be triggered upon detection of at least one critical event, such as water contact for less than a predetermined water contact time (e.g., 1 second shown in FIG. 4 which is not necessarily limiting), the swimmer falling as detected by the accelerometer, the swimmer being out of range for less than a predetermined range time (e.g., 5 seconds shown in FIG. 4 which is not necessarily limiting), or the battery level falling below a predetermined voltage (e.g., 3.3 V shown in FIG. 4 which is not necessarily limiting). These conditions may warrant attention but may not necessarily indicate an immediate emergency.

In some examples, a moderate level alert 301 may be generated for a predetermined water contact time of less than 2 seconds, less than 1 second, less than 0.5 seconds, less than 0.2 seconds, or less than 0.1 seconds. The moderate level alert 301 may also be generated for a predetermined water contact time within ranges of 0.1 seconds to 2 seconds, 0.1 seconds to 1 second, 0.1 seconds to 0.2 seconds, 0.1 seconds to 0.5 seconds, 0.5 seconds to 2 seconds, 1 second to two seconds, or any combination thereof. These various time thresholds may allow for customization of the alert sensitivity based on the specific needs of the swimmer and the preferences of the caregiver or monitoring individual.

In some examples, moderate level alert 301 may be generated only when the fall lasts longer than a predetermined fall time (e.g., 0.5 seconds shown in FIG. 4 which is not limiting). In some examples, the predetermined fall time may be greater than 0.5 seconds, greater than 1 second, greater than 2 seconds, greater than 5 seconds, 0.5 to 5 seconds, 1 to 5 seconds, 2 to 5 seconds, 1-2 seconds or any combination thereof.

The moderate level alert 301 may be generated when the swimmer is out of range for less than 10 seconds, less than 5 seconds, less than 4 seconds, less than 3 seconds, less than 2 seconds, or less than 1 second. The moderate level alert 301 may also be generated when the swimmer is out of range for a time period within ranges of 1-10 seconds, 1-5 seconds, 1-4 seconds, 1-3 seconds, 1-2 seconds, 5-10 seconds, 4-10 seconds, 3-10 seconds, 2-10 seconds, 4-5 seconds, 2-3 seconds, or any combination thereof. These range time thresholds may provide flexibility in configuring the system to balance sensitivity and specificity of alerts based on user preferences and safety requirements.

The moderate level alert 301 may be generated when the battery level falls below a predetermined voltage of less than 4V, less than 3V, less than 2V, or less than 1V. The moderate level alert 301 may also be generated when the battery level falls within voltage ranges of 1-4V, 1-3V, 1-2V, 2-3V, or 2-4V. These voltage thresholds may enable early notification of potential battery issues before they become critical, allowing users to recharge the wearable device 200 in a timely manner. The moderate level alert 301 may also be generated when the battery percentage falls below predetermined thresholds such as less than 20%, less than 10%, less than 5%, or less than 1%. The moderate level alert 301 may also be generated when the battery percentage falls within ranges of 1% to 20%, 1% to 10%, 1% to 5%, or 5% to 10%.

The high alert 302 may be triggered in more severe circumstances, such as when the water contact sensor detects water for greater than or equal to a predetermined water contact time (e.g., 4 seconds shown in FIG. 4 which is not necessarily limiting), indicating that the wearable device 200 has been submerged. This may suggest a potential drowning situation that requires immediate attention. In some examples, the high alert 302 may be triggered when the water contact sensor detects water for a predetermined contact time greater than 3 seconds, greater than 4 seconds, greater than 5 seconds, greater than 6 seconds, greater than 7 seconds, greater than 8 seconds, greater than 9 seconds, or greater than 10 seconds. The high alert 302 may also be triggered when the water contact sensor detects water for a predetermined contact time within ranges of 3-10 seconds 4-10 seconds, 5-10 seconds, 6-10 seconds, 7-10 seconds, 8-10 seconds, 9-10 seconds, 4-9 seconds, 4-8 seconds, 4-7 seconds, 4-6 seconds, 4-5 seconds, 3-9 seconds, 3-8 seconds, 3-7 seconds, 3-6 seconds, 3-5 seconds, 3-4 seconds, 6-9 seconds, 5-8 seconds, 6-7 seconds, or any combination thereof. These various time thresholds may allow for customization of the alert sensitivity based on the specific needs of the swimmer and the preferences of the caregiver or monitoring individual.

In some examples, the high alert 302 may be triggered upon the occurrence of at least two critical events, such as the swimmer falling and being out of range, the swimmer falling and the water contact sensor detecting water, the detection of water and the swimmer being out of range, or any combination thereof. The combination of multiple critical events may increase the likelihood of a dangerous situation, justifying the higher alert level.

The alert schema may be designed to minimize false alarms while ensuring that potentially dangerous situations receive appropriate attention. By differentiating between moderate and high alerts, the system may provide a nuanced approach to swimmer safety, allowing caregivers to respond proportionally to the perceived level of risk.

The alert schema may utilize these definitions to determine when to activate specific notification pathways. For example, when a moderate level alert 301 is triggered, the system may activate a yellow alarm pathway, which may include app push notifications, yellow visual indicators on the poolside alert device 102, and moderate-priority alerts to connected devices. Similarly, when a high level alert 302 is triggered, the system may activate a red alarm pathway, which may include critical notifications with sound, red visual indicators, siren noises, or any combination thereof, from the poolside alert device 102.

Nevertheless, the above distinctions are not exhaustive, and any combination thereof may be present or absent depending on the specific embodiment. While this figure demonstrates specific instances, all potential permutations of conditions and timings fall within the scope of the present disclosure, as long as the prerequisites for a high alert 302 imply greater severity compared to those for a medium alert 301. The differentiating factors include, but are not limited to, the exclusive association of fall detection with high alerts, or a high-water contact threshold potentially denoting longer exposure or greater water volume relative to the medium threshold. The time duration associated with being out of range may also be distinguished, being longer for high alerts compared to medium ones. These differentiators, while illustrative, are not exhaustive, allowing for various embodiments.

In some examples, the system can be augmented by integrating environmental sensors such as temperature and pH sensors, which provide real-time data on water conditions that could pose health risks, such as hypothermia or unsafe pH levels. Additionally, the inclusion of advanced biometric sensors, capable of monitoring heart rate, blood oxygen levels, and skin temperature, facilitates early detection of physiological distress or health complications, enhancing the safety protocols beyond mere movement and submersion detection.

In addition, to extend communication capabilities, the incorporation of mesh network technology enables the wearable devices to interact over extended ranges and through indirect paths if direct communication is compromised. This is particularly vital in large aquatic environments where a direct line of communication to the base station might not be viable. Moreover, the system can support two-way communication, allowing not only for alerts to be sent from the wearable but also for signals to be transmitted back to the wearable device 200, enabling functionality enhancements such as remote activation of the device's light or sound to locate a swimmer or to warn them of potential dangers.

Further, by employing advanced digital signal processing, the system can enhance the clarity and reliability of distress signals even in challenging conditions such as choppy waters. The integration of energy-harvesting technologies, such as those that utilize kinetic energy from water motion, could significantly augment battery longevity for continuous monitoring. Materials and coatings designed to withstand aquatic conditions, resistant to factors like salt water corrosion, UV damage, and biological fouling may be useful for maintaining device integrity and functionality.

Various embodiments allow for flexible system configurations, which may include the wearable device and a smartphone, with the possibility of a poolside alert device 102 tailored to specific needs and environments. While the system offers flexibility, some implementations may require all three components for complete setup to maximize effectiveness and coverage. This setup is not prescribed but offered as one among many potential configurations, emphasizing the system's adaptability to minimal or fully integrated solutions.

In some examples, the poolside alert device 102 features an integrated alert system capable of providing immediate vicinity notifications and can function independently or in conjunction with the smartphone through Bluetooth connectivity. This enables extensive integration possibilities with nearly any compatible device, such as, but not limited to, smart home systems, vehicles, and water sports equipment such as jet skis. Furthermore, the system design can support the inclusion of multiple alert devices, creating comprehensive safety networks suitable for various operational contexts. Additionally, features such as a snooze option can be included to manage and temporarily silence non-critical alerts, allowing users to customize alert management based on situational demands.

Specific non-limiting aspects of the present disclosure are now provided by way of example only:

Example 1: A system for swimmer safety comprising: at least one alert device; and a wearable device configured to be worn by a swimmer, the wearable device comprising: a water contact sensor configured to determine when an amount of water surrounding the wearable device exceeds a predetermined water contact threshold; an accelerometer configured to detect whether the swimmer has fallen; and a range detector configured to determine when the swimmer is out of a range of the at least one alert device, where the wearable device is configured to transmit at least one alert to the at least one alert device upon at least one of: the amount of water surrounding the wearable device exceeding the predetermined water contact threshold, as determined by the water contact sensor, the swimmer falling, as detected by the accelerometer, the swimmer being out of the range of the at least one alert device for a predetermined amount of time, as determined by the range detector, or any combination thereof.

Example 2: The system of Example 1, where the at least one alert device comprises a smartphone, a standalone poolside alert device, or any combination thereof.

Example 3: The system of Example 2, where the wearable device comprises a wristband, a hip clip, or any combination thereof.

Example 4: The system of Example 3, where at least one of the water contact sensor, the accelerometer, the range detector, or any combination thereof, is present on or within at least one insertable component configured to be inserted within the wearable device.

Example 5: The system of Example 4, where the water contact sensor, the accelerometer, and the range detector are present on a sensor module, where the sensor module is configured to be inserted within a compartment of the wearable device.

Example 6: The system of any of Examples 1-4, where the wearable device comprises at least one waterproof material.

Example 7: The system of any of Examples 1-4, where the water contact sensor comprises a plurality of pins configured to actuate upon reaching the predetermined water contact threshold.

Example 8: The system of any of Examples 1-4, where the range detector is configured to detect frequencies ranging from 1 GHz to 10 GHz, is Wi-Fi enabled, is Bluetooth enabled, or any combination thereof.

Example 9: The system of any of Examples 1-4, where the at least one alert comprises: a moderate level alert, and a high level alert; where the moderate level alert is defined as being lower than the high level alert, and where the high level alert is defined as being higher than the moderate level alert.

Example 10: The system of Example 9, where the moderate level alert is triggered by: the amount of water surrounding the wearable device exceeding a predetermined moderate water contact threshold, the swimmer being out of a range of the at least one alert device for a predetermined moderate amount of time, or any combination thereof.

Example 11: The system of Example 9 or 10, where the high-level alert is triggered by: the amount of water surrounding the wearable device exceeding a predetermined high water contact threshold, the swimmer falling, as detected by the accelerometer, the swimmer being out of a range of the at least one alert device for a predetermined high amount of time, or any combination thereof.

Example 12: A wearable device for swimmer safety comprising: a water contact sensor configured to determine when an amount of water surrounding the wearable device exceeds a predetermined water contact threshold; an accelerometer configured to determine whether the swimmer has fallen; and a range detector configured to determine when the swimmer is out of a range of at least one alert device, where the wearable device is configured to transmit at least one alert to at least one alert device upon: the amount of water surrounding the wearable device exceeding the predetermined water contact threshold, as determined by the water contact sensor, the swimmer falling, as detected by the accelerometer, the swimmer being out of the range of the at least one alert device for a predetermined amount of time, as determined by the range detector, or any combination thereof.

Example 13: The wearable device of Example 12, comprising a wristband, a hip clip, or any combination thereof.

Example 14: The wearable device of Example 13, where at least one of the water contact sensor, the accelerometer, the range detector, or any combination thereof, is present on at least one insertable component within the wearable device.

Example 15: The wearable device of Example 12 or 13, where the wearable device comprises at least one waterproof material.

Example 16: A method for swimmer safety comprising: transmitting, from a wearable device configured to be worn by a swimmer, to at least one alert device, at least one alert upon: an amount of water surrounding the wearable device exceeding a predetermined water contact threshold as determined by a water contact sensor on the wearable device, the swimmer falling as detected by an accelerometer on the wearable device, the swimmer being out of a range of the at least one alert device for a predetermined amount of time as determined by a range detector on the wearable device, or any combination thereof; and notifying at least one user of the at least one alert using the at least one alert device.

Example 17: The method of Example 16, where the at least one alert comprises: a moderate level alert, and a high level alert; where the moderate level alert is defined as being lower than the high level alert, and where the high level alert is defined as being higher than the moderate level alert.

Example 18: The method of Example 17, where the moderate level alert is triggered by: the amount of water surrounding the wearable device exceeding a predetermined moderate water contact threshold, the swimmer being out of a range of the at least one alert device for a predetermined moderate amount of time, or any combination thereof.

Example 19: The method of Example 17 or 18, where the high-level alert is triggered by: the amount of water surrounding the wearable device exceeding a predetermined high water contact threshold, the swimmer falling, the swimmer being out of a range of the at least one alert device for a predetermined high amount of time, or any combination thereof.

Example 20: The method of any of Examples 17-19, where upon transmitting the moderate level alert or the high level alert, the at least one alert device provides a first alert type for the moderate level alert and a second alert type for the high level alert.

Example 21: A system for swimmer safety comprising: at least one alert device; and a wearable device configured to be worn by a swimmer, the wearable device comprising: a water contact sensor configured to determine when an amount of water surrounding the wearable device exceeds a predetermined water contact threshold; an accelerometer configured to detect whether the swimmer has fallen; and a range detector configured to determine when the swimmer is out of a range of the at least one alert device, where the wearable device is configured to transmit at least one alert, of at least two alert types, to the at least one alert device upon at least one of the following conditions being met: the amount of water surrounding the wearable device exceeding the predetermined water contact threshold, as determined by the water contact sensor, the swimmer falling, as detected by the accelerometer, and the swimmer being out of the range of the at least one alert device for a predetermined amount of time, as determined by the range detector.

Example 22: The system of Example 21, where the at least two alert types comprise a medium alert and a high alert.

Example 23: The system of Example 22, where the wearable device is configured to transmit the at least one high alert to the at least one alert device upon all three of the following conditions being met: the amount of water surrounding the wearable device exceeding the predetermined water contact threshold, as determined by the water contact sensor, the swimmer falling, as detected by the accelerometer, and the swimmer being out of the range of the at least one alert device for a predetermined amount of time, as determined by the range detector.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein. Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

All prior patents, publications, and test methods referenced herein are incorporated by reference in their entireties.

Variations, modifications and alterations to embodiments of the present disclosure described above will make themselves apparent to those skilled in the art. All such variations, modifications, alterations and the like are intended to fall within the spirit and scope of the present disclosure, limited solely by the appended claims.

Any feature or element that is positively identified in this description may also be specifically excluded as a feature or element of an embodiment of the present disclosure as defined in the claims.

The disclosure described herein may be practiced in the absence of any element or elements, limitation or limitations, which is not specifically disclosed herein. Thus, for example, in each instance herein, any of the terms “comprising,” “consisting essentially of and “consisting of” may be replaced with either of the other two terms. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A system for swimmer safety comprising:
at least one alert device; and
a wearable device configured to be worn by a swimmer, the wearable device comprising:
a water contact sensor configured to determine when an amount of water surrounding the wearable device exceeds a predetermined water contact threshold;
an accelerometer configured to detect whether the swimmer has fallen.
a range detector configured to determine when the swimmer is out of a range of the at least one alert device, where the range detector comprises a Bluetooth Low Energy (BLE) transmitter;
a battery; and
a real-time state management controller, where the real-time state management controller is configured to:
receive inputs from the water contact sensor, the accelerometer, the battery, and the range detector;
manage an operational state of the wearable device based on the inputs; and
generate real-time state data comprising BLE advertisement data indicating when a water threshold is exceeded, a fall is detected, the wearable device is out of range,
a battery level falls below a predetermined voltage, or
any combination thereof;
where the wearable device is configured to transmit, via the BLE transmitter, at least one alert to the at least one alert device upon at least one critical event comprising:
the amount of water surrounding the wearable device exceeding the predetermined water contact threshold, as determined by the water contact sensor,
the swimmer falling, as detected by the accelerometer
the swimmer being out of the range of the at least one alert device for a predetermined amount of time, as determined by the range detector,
the battery level falling below a predetermined voltage, or
any combination thereof.

2. The system of claim 1, wherein the real-time state management controller is further configured to:
update device flags within the at least one alert device based on the real-time state data; and
incorporate the device flags into BLE advertisement data on the at least one alert device.

3. The system of claim 2, where the device flags comprise at least one of: a device firmware upgrade (DFU) ready flag, an enter sleep mode flag, a water sensor wet flag, a device submerged flag, a low battery flag, and a fall detect flag.

4. The system of claim 2, where the real-time state management controller is configured to transmit the BLE advertisement data at a first rate during normal operation; and transmit the BLE advertisement data at a second rate higher than the first rate when the at least one critical event is detected.

5. The system of claim 4, where the first rate is between 1 Hz and 10 Hz.

6. The system of claim 4, where the second rate is between 20 Hz and 100 Hz.

7. The system of claim 1, wherein the operational state comprises at least one of: a sleep state, an active state, a critical event triggered state, and a charging state.

8. The system of claim 1, where the at least one alert device comprises a smartphone, a standalone poolside alert device, or any combination thereof.

9. The system of claim 1, where the wearable device comprises a wristband, a hip clip, a necklace, an ankle bracelet, a ring, goggles, a swim cap, or any combination thereof.

10. The system of claim 1, where the wearable device comprises at least one waterproof material.

11. The system of claim 1, where the water contact sensor comprises a plurality of pins configured to actuate upon reaching the predetermined water contact threshold.

12. The system of claim 1, where the at least one alert comprises a moderate level alert, where the moderate level alert is triggered upon an occurrence of at least one critical event chosen from:
the amount of water surrounding the wearable device exceeding the predetermined water contact threshold, as determined by the water contact sensor detecting water for less than a predetermined amount of a water contact time;
the swimmer falling, as detected by the accelerometer detecting a fall;
the swimmer being out of the range of the at least one alert device for less than a predetermined amount of range time, as determined by the range detector,
the battery level falling below a predetermined voltage, or
any combination thereof.

13. The system of claim 1, where the at least one alert comprises a high level alert, where the high level alert is triggered upon the amount of water surrounding the wearable device exceeding the predetermined water contact threshold, as determined by the water contact sensor detecting water for greater than or equal to a predetermined amount of a water contact time, indicating that the wearable device has been submerged.

14. The system of claim 13, where the high level alert is triggered upon an occurrence of at least two critical events chosen from:
the swimmer falling, as detected by the accelerometer detecting a fall;
the swimmer being out of the range of the at least one alert device; or
the water contact sensor detecting water.

15. A method for swimmer safety comprising:
detecting, by a wearable device configured to be worn by a swimmer, at least one critical event comprising:
an amount of water surrounding the wearable device exceeding a predetermined water contact threshold, as determined by a water contact sensor of the wearable device,
the swimmer falling, as detected by an accelerometer of the wearable device;
the swimmer being out of range of at least one alert device for a predetermined amount of time, as determined by a range detector of the wearable device, where the range detector comprises a Bluetooth Low Energy (BLE) transmitter;
a battery level falls below a predetermined voltage;
or any combination thereof;
generating, by a real-time state management controller of the wearable device, real-time state data comprising BLE advertisement data indicating when a water threshold is exceeded, a fall is detected, the wearable device is out of range, the battery level falls below a predetermined voltage, or any combination thereof; and
transmitting, via the BLE transmitter, at least one alert to the at least one alert device upon detection of the at least one critical event.

16. The method of claim 15, further comprising:
updating device flags within the at least one alert device based on the real-time state data; and
incorporating the device flags into BLE advertisement data on the at least one alert device.

17. The method of claim 16, wherein the device flags comprise at least one of: a device firmware upgrade (DFU) ready flag, an enter sleep mode flag, a water sensor wet flag, a device submerged flag, a low battery flag, and a fall detect flag.

18. The method of claim 16, further comprising:
transmitting the BLE advertisement data at a first rate during normal operation; and
transmitting the BLE advertisement data at a second rate higher than the first rate when the at least one critical event is detected.

19. The method of claim 15, further comprising: managing an operational state of the wearable device based on inputs from the water contact sensor, the accelerometer, and the range detector, wherein the operational state comprises at least one of: a sleep state, an active state, a critical events triggered state, and a charging state.

20. A device for swimmer safety monitoring comprising:
a water contact sensor configured to determine when an amount of water surrounding the device exceeds a predetermined water contact threshold;
an accelerometer configured to detect whether a swimmer wearing the device has fallen;
a range detector comprising a Bluetooth Low Energy (BLE) transmitter configured to determine when the device is out of range of at least one alert device;
a battery; and
a real-time state management controller configured to:
receive inputs from the water contact sensor, the accelerometer, and the BLE transmitter;
manage an operational state of the device based on the inputs;
generate real-time state data comprising BLE advertisement data indicating when a water threshold is exceeded, a fall is detected, or the device is out of range; and
transmit, via the BLE transmitter, at least one alert to the at least one alert device upon at least one critical event comprising:
the amount of water surrounding the device exceeding the predetermined water contact threshold, as determined by the water contact sensor,
the swimmer falling, as detected by the accelerometer,
the device being out of range of the at least one alert device for a predetermined amount of time, as determined by the BLE transmitter,
a battery level falling below a predetermined voltage, or
any combination thereof.
